(19) United States
(12) Patent Application Publication
(10) Pub. No.: US 2008/0278412 A1
(43) Pub. Date: Nov. 13, 2008

(54) CIRCUIT AND METHOD FOR ADJUSTING GRAY SCALE OF PLASMA DISPLAY PANEL

(75) Inventors: Meng-Chao Kao, Taipei (TW); Tzu-Chiang Shen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/746,062

(22) Filed: May 9, 2007

(51) Int. Cl. G09G 3/28

(52) U.S. Cl. 345/60

(57) ABSTRACT

A method for adjusting gray scale of a plasma display panel (PDP) including receiving a frame and detecting a maximum-displaying gray scale of the gray scale distribution of the frame. As a result, the present invention extends the range of the gray scale distribution of the frame to a maximum range, which the PDP can display, according to the ratio between a maximum predetermined gray scale of the gray scale distribution that the PDP can display and the maximum-displaying gray scale.

### BACKGROUND OF THE INVENTION

1. Field of the Invention

The present invention relates to a method for adjusting the gray scale of a plasma display panel (PDP), and more particularly, to a method for adjusting the gray scale of a PDP through extending the range of gray scale distribution of a frame.

2. Description of Related Art

The earliest type of dynamic pictures to be perceived by human were documentary movies. Later on, with the invention of cathode ray tube (CRT), commercialized televisions were successfully promoted so that televisions have become an indispensable home product for each family. However, the variety of CRT-based displays has radiation problem. Moreover, the electron gun inside the CRT renders the display bulky and takes up a large space. Hence, it is difficult to build a light, thin and large scale display product using CRT.

Due to the foregoing problem, researchers are actively engaged in the development of flat panel display. In particular, with the advantages of a large viewing angle, good image quality and scalability, plasma display panel (PDP) is often applied to digital television and has a large marketing potential.

FIG. 1 is a diagram showing the brightness ratios of the sub-fields of a plasma display panel. As shown in FIG. 1, the plasma display panel utilizes the control of sustained pulse to produce different brightness. In general, the method of displaying the gray scale of the plasma display panel includes distributing the sustained pulse of one field (generally 1/60 second) to several sub-fields such that each sub-field has several different numbers of sustained pulses.

In FIG. 1, one field is divided into 9 sub-fields SF0˜SF8 and each sub-field includes a fixed address period 102 and a sustained discharge period 104 that varies according to the number of sustained pulses. In general, the greater the number of sustained pulses, the longer will be the sustained discharge period 104. Assume that the plasma display panel uses 8 bits to represent the gray scale, altogether 256 gray scales (0˜255) can be represented.

For a plasma display panel capable of displaying an 8-bit gray scale distribution, not every frame has to use all the 256 gray scales. In some darker frames, only a few number of the gray scale is actually used to represent the frame. Moreover, with the foregoing method of driving the plasma display panel, more sustained pulses are used to represent the frame when a darker frame is displayed so that a fixed power is consumed.

Assume the weight ratios of the sub-fields are 1:2:4:7:12:22:39:71:97. When displaying a darker frame, assume that twice the number of pulses is required, then the weight ratios of the sub-fields are changed to 2:4:8:14:24:44:78:142:194. Because the difference in the corresponding weight ratios of the sub-fields are larger, a greater difference between the least brightness (LSB) and the “0” gray scale of a dark frame will result. This leads to the observation of noise and a feeling of a rugged gray scale variation.

### SUMMARY OF THE INVENTION

Accordingly, the present invention is directed to provide a method for adjusting the gray scale of a plasma display panel (PDP) capable of extending the level of gray scale distribution of the frame when the PDP displays a darker frame.

The present invention is further directed to provide a circuit for adjusting the gray scale of a plasma display panel (PDP) so as to improve the gray scale of a frame.

As embodied and broadly described herein, the invention provides a method for adjusting the gray scale of a plasma display panel (PDP). The method includes receiving a frame and detecting a maximum-displaying gray scale of the gray scale distribution of the frame. As a result, the present invention extends the range of the gray scale distribution of the frame to a maximum range, which the PDP can display, according to the ratio between a maximum predetermined gray scale of the gray scale distribution that the PDP can display and the maximum-displaying gray scale.

In one preferred embodiment of the present invention, the method further includes dividing the maximum predetermined gray scale by the maximum-displaying gray scale of the frame to obtain a scaling factor. Furthermore, the gray scale distribution data of the frame is multiplied by the scaling factor to obtain a new gray scale distribution data of the frame. Therefore, the present invention is able to use the sub-fields of each frame to provide a new gray scale distribution required by the frame.

In one preferred embodiment of the present invention, the method further includes dividing the frequency of the sustained pulses by the scaling factor to prevent frame distortion.

The prevent invention provides a circuit suitable for adjusting the gray scale of a plasma display panel (PDP) including a gray scale statistical unit, an operational unit and a multiplier. The gray scale statistical unit receives a frame and performs an analysis of the gray scale distribution of the frame to find the maximum-displaying gray scale. The operating unit divides the maximum predetermined gray scale of the gray scale distribution that the PDP can display by the maximum-displaying gray scale to obtain a scaling factor. Then, the gray scale distribution data of the frame and the scaling factor are multiplied together through the multiplier and the result of the multiplication is output.

The present invention extends the range of the gray scale distribution of the frame to a maximum range, which the PDP can display, according to the ratio between a maximum predetermined gray scale of the gray scale distribution that the PDP can display and the maximum-displaying gray scale. Hence, the present invention can display tinier variation in a darker frame, thereby enhancing the gray scale performance of the PDP.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the brightness ratios of the sub-fields of a plasma display panel.

FIG. 2A is a diagram showing an 8-bit gray scale distribution.

FIG. 2B is a diagram showing the gray scale distribution of an extended frame according to one preferred embodiment of the present invention.

FIG. 3 is a flow diagram showing the steps for adjusting the gray scale of a PDP according to one preferred embodiment of the present invention.

FIG. 4 is a block diagram of a circuit for adjusting the gray scale of a frame according to one preferred embodiment of the present invention.

FIG. 5 is a block diagram of a circuit for adjusting the gray scale of a frame according to another preferred embodiment of the present invention.

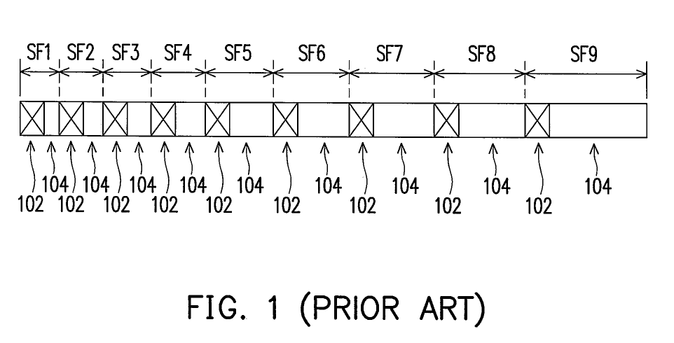

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

One preferred embodiment of the present invention is described in the following. To further the understanding and spirit of the present invention of those having common knowledge in the area of this field, a plasma display panel (PDP) having an 8-bit gray scale distribution is illustrated as an example in the following description. However, this should by no means limit the scope of the present invention.

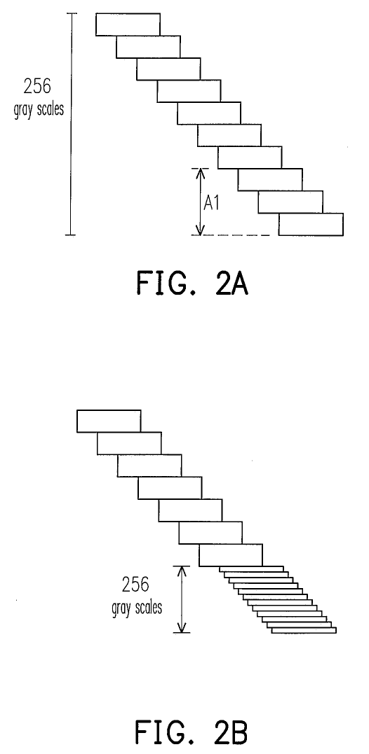

FIG. 2A is a diagram showing an 8-bit gray scale distribution. As shown in FIG. 2A, a PDP having a maximum of 8-bit gray scale distribution means that the gray scale distribution can have 256 gray scales. However, not each of the frames requires all these 256 gray scales of the gray scale distribution. For example, some darker frames may only use a range A1 of the gray scale distribution.

FIG. 2B is a diagram showing the gray scale distribution of an extended frame according to one preferred embodiment of the present invention. If only a small range of the gray scale distribution of a frame is used, small variations in the gray scale distribution cannot be displayed clearly and the feeling of rugged gray scale variation may appear. Therefore, the present invention is directed to extend the range A1 of the gray scale distribution of the frame to the maximum range of the gray scale distribution that the PDP can display while retaining the original brightness of the frame to prevent distortion.

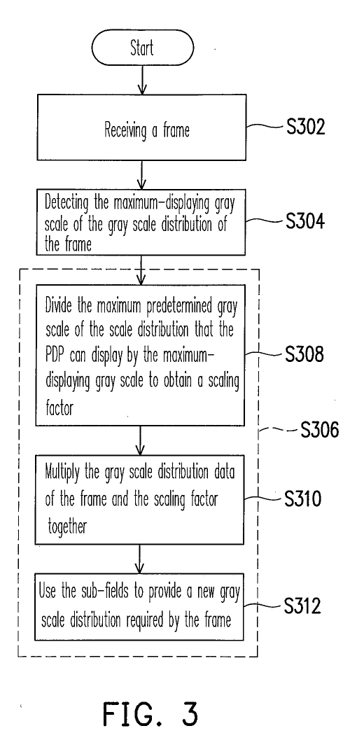

FIG. 3 is a flow diagram showing the steps for adjusting the gray scale of a PDP according to one preferred embodiment of the present invention. As shown in FIG. 3, after receiving a frame in step S302, the maximum-displaying gray scale of the gray scale distribution of the frame is detected in step S304. Then, according to a ratio between a maximum predetermined gray scale of the gray scale distribution that the PDP can show and the maximum-displaying gray scale, the gray scale distribution of the frame is extended to a maximum range, which the PDP can show, in step S306.

Assume that the gray scale data of the PDP is 8 bit long so that the gray scale distribution can have 256 (0˜255) gray scales. In other words, the maximum predetermined gray scale of the PDP is 255. Furthermore, assume that the gray scale distribution of the received frame only has 65 (0˜64) gray scales, then the maximum-displaying gray scale is 64.

After detecting the maximum-displaying gray scale of the frame, the maximum predetermined gray scale of the PDP can be divided by the maximum-displaying gray scale to obtain a scaling factor. Assume the maximum predetermined gray scale is 256 and the maximum-displaying gray scale is 64, then 256 is divided by 64 to obtain a scaling factor of 255/64 as shown in step S308.

Next, as shown in step S310, the received gray scale distribution data of the frame and the scaling factor (255/64) are multiplied together to extend the range of the gray scale distribution of the frame. Thus, as shown in step S312, the sub-fields of each frame are used to provide a new gray scale distribution required by the frame.

After multiplying the gray scale distribution data of the frame with the scaling factor, the brightness of the frame will increase leading to some distortion. Sine the gray scale distribution of each frame in the PDP is determined by the plurality of sub-fields and each sub-field has a fixed address period and a plurality of sustained discharge period, sustained pulses that control the PDP during the sustained discharge periods of each sub-field. Therefore, the frequency of the sustained pulse may control the brightness of the frame.

Therefore, in the present embodiment of the present invention, the method may further include dividing the frequency of the sustained pulse by the foregoing scaling factor to keep the original brightness of the frame. In an alternative embodiment, a suitable frequency of the sustained pulse can be obtained from a look-up table.

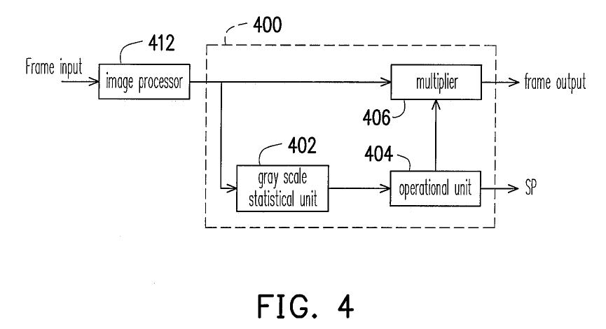

FIG. 4 is a block diagram of a circuit for adjusting the gray scale of a frame according to one preferred embodiment of the present invention. As shown in FIG. 4, the circuit 400 for adjusting the gray scale includes a gray scale statistical unit 402, an operational unit 404 and a multiplier 406. In the present embodiment, the gray scale adjusting circuit 400 is coupled to an image processor 412 for extending the gray scale distribution of a frame.

After receiving a frame, the image processor 412 transmits the frame to the gray scale statistical unit 402 of the gray scale adjusting circuit 400. The gray scale statistical unit 402 performs an analysis to find the maximum-displaying gray scale of the gray scale distribution of the received frame. The result of the analysis is transmitted to the operational unit 404. After receiving the result output from the gray scale statistical unit 402, the operational unit 404 divides the maximum predetermined gray scale of the gray scale distribution that the PDP can display by the maximum-displaying gray scale of the received frame so as to obtain a scaling factor. Then, the multiplier 406 will multiply the input gray scale distribution data of the frame and the scaling factor together to obtain a new gray scale distribution of the frame.

Furthermore, after obtaining the scaling factor, the operational unit 404 modulates the frequency of the sustained pulse (SP) in accordance with the scaling factor. In the present embodiment, the operational unit 404 may divide the frequency of the sustained pulse SP by the scaling factor. In an alternative embodiment, the operational unit 404 may find the most suitable frequency of the sustained pulse SP through a table look-up in accordance with the scaling factor.

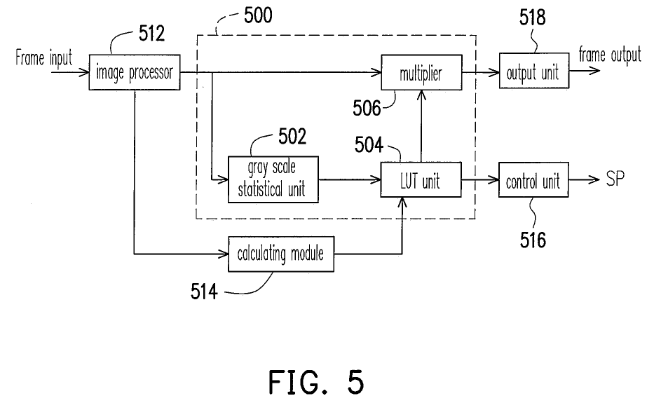

FIG. 5 is a block diagram of a circuit for adjusting the gray scale of a frame according to another preferred embodiment of the present invention. As shown in FIG. 5, the circuit 500 for adjusting the gray scale includes a gray scale statistical unit 502, a multiplier 506 and a LUT (Look-Up Table) unit 504. The circuit 500 of the embodiment is similar with the circuit 400 shown in FIG. 4 except that the maximum predetermined gray scale of the gray scale distribution is calculated outside the circuit 500. In other words, the circuit 500 merely performs a look-up procedure.

Specifically, when the input frame is received by the image processor 512, the input frame is transmitted to multiplier 506, the gray scale statistical unit 502 and an external calculating module 514. Similar with the gray scale statistical unit 402, the gray scale statistical unit 502 performs an analysis to find the maximum-displaying gray scale of the gray scale distribution of the received frame and the result of the analysis is transmitted to the LUT unit 504. Additionally, the maximum predetermined gray scale of the gray scale distribution is calculated by the external calculating module 514. According to the result output from the gray scale statistical unit 502 and the maximum predetermined gray scale of the gray scale distribution calculated by the external calculating module 514, the LUT unit 504 performs a look-up procedure so as to obtain a scaling factor. At this time, the LUT unit 504 transmits the scaling factor to a control unit 516 so as to find the most suitable frequency of the sustained pulse SP.

In addition, LUT unit 504 transmits the scaling factor to the multiplier 506 and the multiplier 506 multiplies the input gray scale distribution data of the frame and the scaling factor together to obtain a new gray scale distribution of the frame. Then, the multiplier 506 transmits the processed frame to the output unit 518 so as to provide a new output frame.

In summary, the gray scale distribution data of the input frame and the scaling factor, which is obtained through dividing the maximum-displaying gray scale of the gray scale distribution of the frame by the maximum predetermined gray scale of the gray scale distribution that the PDP can display, are multiplied together. Thus, the present invention is able to extend the range of the gray scale distribution of the frame so that a smaller gray scale variation can be displayed and a finer gray scale modulation can be obtained.

In addition, the frequency of the sustained pulse is modulated according to the scaling factor so that the brightness of the original frame is kept. Thus, the present invention is able to prevent frame distortion.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting the gray scale of a plasma display panel (PDP), comprising:
receiving a frame;
detecting a maximum-displaying gray scale of a gray scale distribution that the frame is able to display; and
extending a range of the gray scale distribution of the frame to a maximum range that the PDP is able to display according to the ratio between a maximum predetermined gray scale of the gray scale distribution that the PDP is able to display and the maximum-displaying gray scale.

2. The method of claim 1, wherein the frame has a plurality of sub-fields.

3. The method of claim 2, wherein the step for extending the range of the gray scale distribution of the frame comprises:
dividing the maximum predetermined gray scale by the maximum-displaying gray scale to obtain a scaling factor;
multiplying gray scale distribution data of the frame by the scaling factor to extend the range of the gray scale distribution of the frame to the maximum range of the gray scale distribution that the PDP is able to display; and
using the sub-fields to provide a new gray scale distribution required by the frame.

4. The method of claim 2, wherein each sub-field has a fixed address period and a plurality of sustained discharge periods such that a sustained pulse controls the PDP during the sustained discharge periods.

5. The method of claim 4, wherein a frequency of the sustained pulse is modulated according to the ratio between the maximum predetermined gray scale and the maximum-displaying gray scale.

6. The method of claim 5, further comprising dividing the frequency of the sustained pulse by the scaling factor obtained by dividing the maximum predetermined gray scale by the maximum-displaying gray scale.

7. A circuit suitable for adjusting the gray scale of a plasma display panel (PDP), comprising:
a gray scale statistical unit for receiving a frame and performing an analysis of the frame to find a maximum-displaying gray scale of the gray scale distribution of the frame;
an operational unit for dividing the maximum predetermined gray scale that the PDP is able to display by the maximum-displaying gray scale to obtain a scaling factor; and
a multiplier for multiplying gray scale distribution data of the frame and the scaling factor together and outputting the result.

8. The circuit for adjusting the gray scale of claim 7, wherein the frame has a plurality of sub-fields and each sub-field has a fixed address period and a plurality of sustained discharge periods such that a sustained pulse controls the PDP during the sustained discharged periods.

9. The circuit for adjusting the gray scale of claim 8, wherein the operational unit further divides the frequency of the sustained pulse by the scaling factor to reduce the brightness of the frame.

10. The circuit for adjusting the gray scale of claim 8, wherein the operational unit modulates the frequency of the sustained pulse according to the scaling factor and a look-up table so that the frame is able to maintain a suitable brightness.

11. A circuit suitable for adjusting the gray scale of a plasma display panel (PDP), comprising:
a gray scale statistical unit for receiving a frame and performing an analysis of the frame to find a maximum-displaying gray scale of the gray scale distribution of the frame;
a look-up table unit for looking up a scaling factor according to the maximum predetermined gray scale that the PDP is able to display; and
a multiplier for multiplying gray scale distribution data of the frame and the scaling factor together and outputting the result.

12. The circuit for adjusting the gray scale of claim 11, wherein the frame has a plurality of sub-fields and each sub-field has a fixed address period and a plurality of sustained discharge periods such that a sustained pulse controls the PDP during the sustained discharged periods.
